(19) United States
(12) Patent Application Publication
(10) Pub. No.: US 2025/0200439 A1
(43) Pub. Date: Jun. 19, 2025

(54) SYSTEM AND METHOD FOR GENERATING A GRAPHICAL USER INTERFACE INCLUDING ENHANCED METRICS BASED ON SHAP QUANTITIES OF A MACHINE LEARNING FORECAST MODEL

(71) Applicant: Kinaxis Inc., Ottawa (CA)

(72) Inventors: Naghmeh KHOSROWABADI, Hamburg (DE); Kevin KISSOON, Toronto (CA); Qin Yun YU, Windsor (CA)

(73) Assignee: KINAXIS INC., Ottawa (CA)

(21) Appl. No.: 18/980,566

(22) Filed: Dec. 13, 2024

Related U.S. Application Data
(60) Provisional application No. 63/609,576, filed on Dec. 13, 2023.

(51) Int. Cl. G06N 20/00; G06Q 10/04

(52) U.S. Cl. CPC G06N 20/00; G06Q 10/04

(57) ABSTRACT

A system and method for generating a graphical user interface including enhanced metrics based on the SHAP quantities of a machine learning forecast model may include: receiving forecast data related to a machine learning forecast model that includes, for each input category of each forecast item at each forecast time, a SHAP quantity and a sign indicating a directionality of the SHAP quantity, based on the SHAP quantities, generating relative magnitude values, directional significance values, and relative contribution values, and outputting in a graphical user interface the relative magnitude values, the directional significance values, and the relative contribution values as Applied and Indicative Explanation values (AIE-values).

The present application claims priority to: U.S. Provisional Patent Application No. 63/609,576, filed Dec. 13, 2023, the entirety of which is hereby incorporated by reference.

### BACKGROUND

Machine learning models are used to make predictions in many different contexts. To facilitate interpretation of the predictions generated by the machine learning model, SHAP (SHapley Additive explanations) quantities may be generated and output together with the prediction. SHAP quantities may provide a measure of how different features (referred to herein as input categories) that are input into the model, contribute to the model's prediction, which may provide information regarding how each feature affects the outcome.

SHAP quantities may be based on game theory and may assign an importance value to each input category in a model. For example, a SHAP quantity may have “+” or “−” signs associated therewith to indicate directionality, such that features with positive SHAP quantities positively impact the prediction, while those with negative quantities have a negative impact. The magnitude associated with an input category may measure how strong the effect of that input category is on the prediction by the model.

In the context of demand or supply planning, machine learning predictions may be difficult for planners to understand while requiring specific skills to avoid misinterpreting the results. Further, the complex mathematical nature of SHAP quantities makes them difficult in terms of effort and time required to grasp their significance and incorporate them into practical decision-making processes, particularly for non-data science experts, such as demand planners. Improvements to machine learning outputs are desired.

### BRIEF SUMMARY

The details of one or more embodiments of the subject matter of this specification are set forth in the accompanying drawings and the description below. Other features, aspects, and advantages of the subject matter may become apparent from the description, the drawings, and the claims.

The present disclosure provides a system and method for generating a graphical user interface that enhances the interpretability of SHAP quantities related to forecast predictions that are generated by a machine learning forecast engine based on a forecast model. The SHAP quantities can be related to time-series forecast predictions.

Existing solutions that generate forecasting predictions using a machine learning forecast models merely provide raw SHAP quantities, which are not well-suited for interpreting time-series forecast predictions, where interpretations by planners are necessary at different product-levels (SKU, brand, brand category, business unit, and so forth) and time buckets (daily, weekly, monthly, quarterly). The raw SHAP quantities, consisting of a magnitude and a direction associated with each feature, do not permit comparison across different forecast items or time periods of the time-series forecast. As a result, it is challenging to translate the SHAP-quantities into actionable insights either because planners don't have the skills nor the time required, thus making interpretation of the results unfeasible. These issues may ultimately lead to incorrect conclusions about the effects of each input category, and their relative magnitudes and directions, on the forecast items. Improving the usability of the forecast predictions, particularly graphical user interfaces utilized to interpret forecast predictions, is desired.

Embodiments of the present disclosure may provide a solution to the above problem by generating enhanced metrics, referred to herein as Applied and Indicative Explanation values (AIE-values), based on the output of conventional machine learning forecast modelling. Such output can include the forecast predictions for different forecast items at different forecast times, and the SHAP quantities associated with the input categories of each forecast item at each forecast time, which are generated by existing machine learning forecasting engines.

The AIE-values generated in accordance with the present disclosure include relative magnitude and directions of the effects of different features across forecast items and forecast times, groupings of forecast items together based on scale, and normalized magnitude and direction of the effects of different features across forecast items and forecast times.

The AIE-values may be displayed in a graphical user interface to enable a user to navigate, understand, and derive insights from the forecasts that are not readily provided by the raw SHAP data, thereby resulting in improved usability, and facilitating more accurate interpretations of the influence of input categories on the forecast predictions for various forecast items over time. For example, the AIE-values, as well as the visualizations enabled by the graphical user interface of the embodiments described herein, can enable a user to make better decisions with an improved understanding of complex relationships within a supply chain network in way that could not have been easily deduced from raw SHAP values. Problem detection, investigation, evaluation and resolution may be faster using AIE-values compared to the use of a spreadsheet-based or tabular visualization of raw SHAP values.

By generating AIE-values, the embodiments of the present disclosure improve the overall usability of a computer system that provides forecast prediction data by systematically transforming the raw SHAP value data into readily-accessible information. Improving the usability and interpretability of the forecast prediction data reduces the time and, therefore, energy utilized by the computer system for a user to interpret the forecast model results, resulting in a reduction of computation resources compared to conventional computer systems.

Additionally, the embodiments of the present disclosure can be applied to SHAP quantities generated by conventional machine learning forecast engines, without having to perform computationally intensive retraining or reprogramming of an “explainer module” of the machine learning forecast engine that generates SHAP quantities. This provides an improved machine learning forecast computing system, which may leverage existing machine learning forecast engines, while providing results that require less computational resources to interpret.

In an aspect, the present disclosure provides a computer-implemented method that includes receiving forecast data related to a machine learning forecast model that includes, for each input category of each forecast item at each forecast time, a SHAP quantity and a sign indicating a directionality of the SHAP quantity, based on the SHAP quantities, generating relative magnitude values, directional significance values, and relative contribution values, outputting in a graphical user interface the relative magnitude values, the directional significance values, and the relative contribution values as Applied and Indicative Explanation values (AIE-values).

In an example embodiment, generating the relative magnitude values includes, for each forecast item at each forecast time determining, a sum of the absolute SHAP quantities of the forecast item at the forecast time, dividing each absolute SHAP quantity of the forecast item at the forecast time by the determined sum of the absolute SHAP quantities for the forecast item and forecast time to generate, for each category, a percent magnitude value, wherein outputting in a graphical user interface the relative magnitude values comprises outputting in a graphical user interface the percent magnitude values.

In an example embodiment, each of the forecast items in the forecast data is associated with one of a plurality of segments, and generating the relative magnitude values includes, for each forecast item at each forecast time determining a weighting value for each of the plurality of segments, multiplying each percent magnitude value by the weighting value of the segment that is associated with the forecast item that the percent magnitude value is associated with to generate a comparable significance value, wherein outputting in the graphical user interface the relative magnitude values comprises outputting in the graphical user interface the comparable significance values.

In an example embodiment, the forecast data includes, for each forecast item at each time, an associated forecast prediction, and determining the weighting factor for each of the plurality of segments comprises, for each segment dividing the sum of all forecast predictions of all forecast items associated with segment at all forecast times by the sum of all forecast predictions of all forecast items at all forecast times for all segments.

In an example embodiment, generating the relative magnitude values comprises, for each input category, determining an average of the comparable significance values for all forecast items for all segments at each forecast time to generate an overall significance value, and outputting in the graphical user interface the relative magnitude values comprises outputting in the graphical user interface the overall significance values.

In an example embodiment, the forecast data includes, for each forecast item at each time, an associated forecast prediction, and generating the directional significance values includes assigning each forecast item to one of a plurality of scales based on the forecast prediction associated with the forecast item, determining, for each scale, an average of the forecast predictions associated with the forecast items in the scale and setting the determined average to be a new base value, for each forecast item at each time dividing each of the absolute SHAP quantities of the forecast item at the forecast time by a sum of the absolute SHAP quantities of the forecast item at the forecast time to determine percent magnitude values, determining a minimum of the percent magnitude values and dividing the percent magnitude values by the minimum percent magnitude value to generate rescaled percent magnitude values, for each rescaled percent magnitude value, including the sign indicating direction associated with the SHAP quantity associated with the rescaled percent magnitude value and summing of the rescaled percent magnitude values with signs, determining a difference between the forecast prediction of the forecast item at the forecast time and the new base value, dividing the difference by the sum of the rescaled percent magnitude values with signs, multiplying the rescaled percent magnitude values by the result of dividing the difference by the sum of the rescaled percent magnitude values with signs to generate granular directional significance values, dividing by the new base value of the segment and outputting in the graphical user interface the directional significance values comprises outputting in the graphical user interface the granular directional significance values.

In an example embodiment, each of the forecast items in the forecast data is associated with one of a plurality of segments, and generating the directional significance values comprises, for each forecast item at each forecast time determining a weighting value for each of the plurality of segments, multiplying each granular directional significance value by the weighting value of the segment that is associated with the forecast item that the granular directional significance value is associated with and dividing by the new base value of the segment to generate a comparable directional significance value, and outputting in the graphical user interface the directional significance values comprises outputting in the graphical user interface the comparable directional significance values.

In an example embodiment, generating the directional significance values comprises, for each input category and each scale, averaging of the comparable directional significance values for all forecast items at all forecast times for all segments to generate overall directional significance values, and outputting in the graphical user interface the directional significance values comprises outputting in the graphical user interface the overall directional significance values.

In an example embodiment, the forecast data includes, for each forecast item at each time, an associated forecast prediction, each of the forecast items in the forecast data is associated with one of a plurality of segments, and wherein the relative contribution values includes assigning each forecast item to one of a plurality of scales based on the forecast prediction associated with the forecast item, determining, for each scale, a minimum forecast prediction as the minimum forecast, determining a weighting value for each of the plurality of segments, for each forecast item at each time dividing each of the absolute SHAP quantities of the forecast item at the forecast time by a sum of the absolute SHAP quantities of the forecast item at the forecast time to determine percent magnitude values, determining a minimum of the percent magnitude values and dividing the percent magnitude values by the minimum percent magnitude value to generate rescaled percent magnitude value, summing the rescaled percent magnitude values, determining a difference between the forecast prediction of the forecast item at the forecast time and the minimum forecast, dividing the difference by the sum of the rescaled percent magnitude values, multiplying the rescaled percent magnitude values by the result of dividing the difference by the sum of the rescaled percent magnitude values to generate contribution values, and multiplying each contribution value by the weighting value of the segment that is associated with the forecast item that the contribution value is associated with to generate comparable relative contribution values, and outputting in the user interface the relative contribution values comprises outputting in the user interface the comparable relative contribution values.

In an example embodiment, generating the relative contribution values comprises, for each input category and each scale, averaging of the comparable relative contribution values for all forecast items at all forecast times for all segments to generate overall relative contribution values, and outputting in the user interface the relative contribution values comprises outputting in the user interface the overall relative contribution values.

In another aspect, the present disclosure provides a system that includes a processor, and a memory storing instructions that, when executed by the processor, configure the system to receive forecast data related to a machine learning forecast model that includes, for each input category of each forecast item at each forecast time, a SHAP quantity and a sign indicating a directionality of the SHAP quantity, based on the SHAP quantities, generate relative magnitude values, directional significance values, and relative contribution values, and output in a graphical user interface the relative magnitude values, the directional significance values, and the relative contribution values as Applied and Indicative Explanation values (AIE-values).

In an example embodiment, the memory storing instructions that, when executed by the processor, configure the system to generate the relative magnitude values comprises the memory storing instructions that, when executed by the processor, configure the system to, for each forecast item at each forecast time determine, a sum of the absolute SHAP quantities of the forecast item at the forecast time, divide each absolute SHAP quantity of the forecast item at the forecast time by the determined sum of the SHAP quantities for the forecast item and forecast time to generate, for each category, a percent magnitude value, and the memory storing instructions that, when executed by the processor, configure the system to output in a graphical user interface the relative magnitude values comprises the memory storing instructions that, when executed by the processor, configure the system to output in a graphical user interface the granular significance values.

In an example embodiment, each of the forecast items in the forecast data is associated with one of a plurality of segments and the memory storing instructions that, when executed by the processor, configure the system to generate the relative magnitude values comprises the memory storing instructions that, when executed by the processor, configure the system to, for each forecast item at each forecast time determine a weighting value for each of the plurality of segments, multiply each percent magnitude value by the weighting value of the segment that is associated with the forecast item that the percent magnitude value is associated with to generate a comparable significance value, and the memory storing instructions that, when executed by the processor, configure the system to output in a graphical user interface the relative magnitude values comprises the memory storing instructions that, when executed by the processor, configure the system to output in the graphical user interface the comparable significance values.

In an example embodiment, the forecast data includes, for each forecast item at each time, an associated forecast prediction and the memory storing instructions that, when executed by the processor, configure the system to determine the weighting factor for each of the plurality of segments comprises the memory storing instructions that, when executed by the processor, configure the system to, for each segment, divide the sum of all forecast predictions of all forecast items associated with segment at all forecast times by the sum of all forecast predictions of all forecast items at all forecast times for all segments.

In an example embodiment, the memory storing instructions that, when executed by the processor, configure the system to generate the relative magnitude values comprises the memory storing instructions that, when executed by the processor, configure the system to, for each input category, determine an average of the comparable significance values for all forecast items for all segments at each forecast time to generate an overall significance value, and the memory storing instructions that, when executed by the processor, configure the system to output in a graphical user interface the relative magnitude values comprises the memory storing instructions that, when executed by the processor, configure the system to output in the graphical user interface the overall significance values.

In an example embodiment, the memory further stores instructions that, when executed by the processor, configure the system to the forecast data includes, for each forecast item at each time, an associated forecast prediction, and the memory storing instructions that, when executed by the processor, configure the system to generate the directional significance values comprises the memory storing instructions that, when executed by the processor, configure the system to assign each forecast item to one of a plurality of scales based on the forecast prediction associated with the forecast item, determine, for each scale, an average of the forecast predictions associated with the forecast items in the scale and setting the determined average to be a new base value, for each forecast item at each time divide each of the absolute SHAP quantities of the forecast item at the forecast time by a sum of the absolute SHAP quantities of the forecast item at the forecast time to determine percent magnitude values, determine a minimum of the percent magnitude values and dividing the percent magnitude values by the minimum percent magnitude value to generate rescaled percent magnitude values, for each rescaled percent magnitude value, include the sign indicating direction associated with the SHAP quantity associated with the rescaled percent magnitude value and sum of the rescaled percent magnitude values with the signs, determine a difference between the forecast prediction of the forecast item at the forecast time and the new base value, divide the difference by the sum of the rescaled percent magnitude values with the signs, multiply the rescaled percent magnitude values with the signs by the result of dividing the difference by the sum of the rescaled percent magnitude values with the signs and divide by the new base value of the segment to generate granular directional significance values, and the memory storing instructions that, when executed by the processor, configure the system to output in a graphical user interface the directional significance values comprises the memory storing instructions that, when executed by the processor, configure the system to output in the graphical user interface the granular directional significance values.

In an example embodiment each of the forecast items in the forecast data is associated with one of a plurality of segments, and the memory storing instructions that, when executed by the processor, configure the system to generate the directional significance values comprises the memory storing instructions that, when executed by the processor, configure the system to, for each forecast item at each forecast time determine a weighting value for each of the plurality of segments, multiply each granular directional significance value by the weighting value of the segment that is associated with the forecast item that the granular directional significance value is associated with and dividing by the new base value of the segment to generate a comparable directional significance value, and the memory storing instructions that, when executed by the processor, configure the system to output in the graphical user interface the directional significance values comprises the memory storing instructions that, when executed by the processor, configure the system to output in the graphical user interface the comparable directional significance values.

In an example embodiment, the memory storing instructions that, when executed by the processor, configure the system to generate the directional significance values comprises the memory storing instructions that, when executed by the processor, configure the system to, for each input category and each scale, averaging of the comparable directional significance values for all forecast items at all forecast times for all segments to generate overall directional significance values, and the memory storing instructions that, when executed by the processor, configure the system to output in a graphical user interface the relative magnitude values comprises the memory storing instructions that, when executed by the processor, configure the system to output in the graphical user interface the overall directional significance values.

In an example embodiment, the forecast data includes, for each forecast item at each time, an associated forecast prediction, each of the forecast items in the forecast data is associated with one of a plurality of segments, and the memory storing instructions that, when executed by the processor, configure the system to generate the relative contribution values comprises the memory storing instructions that, when executed by the processor, configure the system to assign each forecast item to one of a plurality of scales based on the forecast prediction associated with the forecast item, determine, for each scale, a minimum forecast prediction as the minimum forecast, determine a weighting value for each of the plurality of segments, for each forecast item at each time divide each of the absolute SHAP quantities of the forecast item at the forecast time by a sum of the absolute SHAP quantities of the forecast item at the forecast time to determine percent magnitude values, determine a minimum of the percent magnitude values and divide the percent magnitude values by the minimum percent magnitude value to generate rescaled percent magnitude value, sum the rescaled percent magnitude values, determine a difference between the forecast prediction of the forecast item at the forecast time and the minimum forecast, divide the difference by the sum of the rescaled percent magnitude values, multiply the rescaled percent magnitude values by the result of dividing the difference by the sum of the rescaled percent magnitude values to generate contribution values, and multiplying each contribution value by the weighting value of the segment that is associated with the forecast item that the contribution value is associated with to generate comparable relative contribution values, and the memory storing instructions that, when executed by the processor, configure the system to output in a user interface the relative contribution values comprises the memory storing instructions that, when executed by the processor, configure the system to output in the user interface the comparable relative contribution values.

In an example embodiment, the memory storing instructions that, when executed by the processor, configure the system to generate the relative contribution values comprises the memory storing instructions that, when executed by the processor, configure the system to, for each input category and each scale, average of the comparable relative contribution values for all forecast items at all forecast times for all segments to generate overall relative contribution values, and the memory storing instructions that, when executed by the processor, configure the system to output in a user interface the relative contribution values comprises the memory storing instructions that, when executed by the processor, configure the system to output in the user interface the overall relative contribution values.

In a further aspect, the present disclosure provides a non-transitory computer-readable medium. The computer-readable medium includes instructions that when executed by a computer, cause the computer to receive forecast data related to a machine learning forecast model that includes, for each input category of each forecast item at each forecast time, a SHAP quantity and a sign indicating a directionality of the SHAP quantity, based on the SHAP quantities, generate relative magnitude values, directional significance values, and relative contribution values, and output in a graphical user interface the relative magnitude values, the directional significance values, and the relative contribution values as Applied and Indicative Explanation values (AIE-values).

In an example embodiment, the instructions that, when executed by computer, cause the computer to generate the relative magnitude values comprises instructions that, when executed by the computer, cause the computer to, for each forecast item at each forecast time determine, a sum of the absolute SHAP quantities of the forecast item at the forecast time, divide each absolute SHAP quantity of the forecast item at the forecast time by the determined sum of the absolute SHAP quantities for the forecast item and forecast time to generate, for each SHAP quantity, a percent magnitude value, and the instructions that, when executed by the computer, cause the computer to output in a graphical user interface the relative magnitude values comprises instructions that, when executed by the processor, configure the system to output in a graphical user interface the granular significance values.

In an example embodiment, each of the forecast items in the forecast data is associated with one of a plurality of segments and wherein the instructions that, when executed by the computer, cause the computer to generate the relative magnitude values comprises the instructions that, when executed by the computer, cause the computer to, for each forecast item at each forecast time determine a weighting value for each of the plurality of segments, multiply each percent magnitude value by the weighting value of the segment that is associated with the forecast item that the percent magnitude value is associated with to generate a comparable significance value, and the instructions that, when executed by the computer, cause the computer to output in a graphical user interface the relative magnitude values comprises instructions that, when executed by the computer, cause the computer to output in the graphical user interface the comparable significance values.

In an example embodiment, the forecast data includes, for each forecast item at each time, an associated forecast prediction and the instructions that, when executed by the computer, cause the computer to determine the weighting factor for each of the plurality of segments comprises instructions that, when executed by the computer, cause the computer to, for each segment, divide the sum of all forecast predictions of all forecast items associated with segment at all forecast times by the sum of all forecast predictions of all forecast items at all forecast times for all segments.

In an example embodiment, the instructions that, when executed by the computer, cause the computer to generate the relative magnitude values comprises instructions that, when executed by the computer cause the computer to, for each input category, determine an average of the comparable significance values for all forecast items for all segments at each forecast time to generate an overall significance value, and wherein the instructions that, when executed by the computer, cause the computer to output in a graphical user interface the relative magnitude values comprises instructions that, when executed by the computer, cause the computer to output in the graphical user interface the overall significance values.

In an example embodiment, the forecast data includes, for each forecast item at each time, an associated forecast prediction, and the instructions that, when executed by the computer, cause the computer to generate the directional significance values comprises instructions that, when executed by the computer, cause the computer to assign each forecast item to one of a plurality of scales based on the forecast prediction associated with the forecast item, determine, for each scale, an average of the forecast predictions associated with the forecast items in the scale and setting the determined average to be a new base value, for each forecast item at each time divide each of the absolute SHAP quantities of the forecast item at the forecast time by a sum of the absolute SHAP quantities of the forecast item at the forecast time to determine percent magnitude values, determine a minimum of the percent magnitude values and dividing the percent magnitude values by the minimum percent magnitude value to generate rescaled percent magnitude values, for each rescaled percent magnitude value, include the sign indicating direction associated with the SHAP quantity associated with the rescaled percent magnitude value and sum of the rescaled percent magnitude values with the signs, determine a difference between the forecast prediction of the forecast item at the forecast time and the new base value, divide the difference by the sum of the rescaled percent magnitude values with the signs, multiply the rescaled percent magnitude values with the signs by the result of dividing the difference by the sum of the rescaled percent magnitude values with the signs, and dividing the result by the new base value of the segment to generate granular directional significance values, and the instructions that, when executed by the computer, cause the computer to output in a graphical user interface the directional significance values comprises instructions that, when executed by the computer, cause the computer to output in the graphical user interface the granular directional significance values.

In an example embodiment, each of the forecast items in the forecast data is associated with one of a plurality of segments, and the instructions that, when executed by the computer, cause the computer to generate the directional significance values comprises instructions that, when executed by the computer, cause the computer to, for each forecast item at each forecast time determine a weighting value for each of the plurality of segments, multiply each granular directional significance value by the weighting value of the segment that is associated with the forecast item that the granular directional significance value is associated with and dividing by the new base value of the segment to generate a comparable directional significance value, and the instructions that, when executed by the computer, cause the computer to output in the graphical user interface the directional significance values comprises instructions that, when executed by the computer, cause the computer to output in the graphical user interface the comparable directional significance values.

In an example embodiment, the instructions that, when executed by the computer, cause the computer to generate the directional significance values comprises instructions that, when executed by the computer, cause the computer to, for each input category and each scale, averaging of the comparable directional significance values for all forecast items at all forecast times for all segments to generate overall directional significance values, and the instructions that, when executed by the computer, cause the computer to output in a graphical user interface the directional significance values comprises instructions that, when executed by the computer, cause the computer to output in the graphical user interface the overall directional significance values.

In an example embodiment, the forecast data includes, for each forecast item at each time, an associated forecast prediction, each of the forecast items in the forecast data is associated with one of a plurality of segments, and the instructions that, when executed by the computer, cause the computer to generate the relative contribution values comprises instructions that, when executed by the computer, cause the computer to assign each forecast item to one of a plurality of scales based on the forecast prediction associated with the forecast item, determine, for each scale, a minimum forecast prediction as the minimum forecast, determine a weighting value for each of the plurality of segments, for each forecast item at each time divide each of the absolute SHAP quantities of the forecast item at the forecast time by a sum of the absolute SHAP quantities of the forecast item at the forecast time to determine percent magnitude values, determine a minimum of the percent magnitude values and divide the percent magnitude values by the minimum percent magnitude value to generate rescaled percent magnitude value, sum the rescaled percent magnitude values, determine a difference between the forecast prediction of the forecast item at the forecast time and the minimum forecast, divide the difference by the sum of the rescaled percent magnitude values, multiply the rescaled percent magnitude values by the result of dividing the difference by the sum of the rescaled percent magnitude values to generate contribution values, and multiplying each contribution value by the weighting value of the segment that is associated with the forecast item that the contribution value is associated with to generate comparable relative contribution values, and the instructions that, when executed by the computer, cause the computer to output in a user interface the relative magnitude values comprises instructions that, when executed by the computer, cause the computer to output in the user interface the comparable relative contribution values.

In an example embodiment, the instructions that, when executed by the computer, cause the computer to generate the relative contribution values comprises instructions that, when executed by the computer, cause the computer to, for each input category and each scale, average of the comparable relative contribution values for all forecast items at all forecast times for all segments to generate overall relative contribution values, and the instructions that, when executed by the computer, cause the computer to output in a user interface the relative contribution values comprises instructions that, when executed by the computer, cause the computer to output in the user interface the overall relative contribution values.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for generating a graphical user interface including enhanced metrics based on SHAP quantities of a machine learning forecast model in accordance with one embodiment.

FIG. 2 illustrates a flow chart of an example computer implemented method for generating a graphical user interface including enhanced metrics based on SHAP quantities of a machine learning forecast model in accordance with one embodiment.

FIG. 3 illustrates a flow chart of an example computer implemented method for generating relative magnitude values in accordance with one embodiment.

FIG. 4 is a screenshot of an example graphical user interface including granular significance values generated by the example method of FIG. 3.

FIGS. 5A and 5B are screenshots of example graphical user interfaces including comparable significance values generated by the example method of FIG. 3.

FIGS. 6A and 6B are screenshots of example graphical user interfaces including forecast predictions in accordance with one embodiment.

FIG. 7 is a screenshot of an example graphical user interface including overall significance values generated by the example method of FIG. 3.

FIGS. 8A and 8B illustrate a flow chart of an example computer implemented method for generating directional significance values in accordance with one embodiment.

FIG. 9 is a screenshot of an example graphical user interface including granular directional significance values generated by the example method of FIGS. 8A and 8B.

FIGS. 10A and 10B are screenshots of example graphical user interfaces including comparable directional significance values generated by the example method of FIGS. 8A and 8B.

FIGS. 11A and 11B are screenshots of example graphical user interfaces including overall directional significance values generated by the example method of FIGS. 8A and 8B.

FIGS. 12A and 12B illustrate a flow chart of an example computer implemented method for generating relative contribution values in accordance with one embodiment.

FIG. 13 is a screenshot of an example graphical user interface including comparable relative contribution values generated by the example method of FIGS. 12A and 12B.

FIG. 14 is a screenshot of an example graphical user interface including overall relative contribution values generated by the example method of FIGS. 12A and 12B.

### DETAILED DESCRIPTION

The present disclosure provides system and method for enhancing the interpretability of SHAP-quantities related to forecast predictions generated by a machine learning forecast engine based on a forecast model, particularly time-series forecast predictions.

Existing solutions/software generating forecasting predictions using a machine learning forecast model merely provide raw SHAP quantities, which are not well-suited for time-series forecasts, still mostly used by planners, where interpretations are necessary at different product-levels (SKU, Brand, BU) and time buckets (daily, weekly, monthly, quarterly) because the raw SHAP quantities and associated direction indication do not permit comparison across different forecast items or time periods of the time-series forecast. As a result, users often fail to translate the SHAP-quantities into actionable insights. These issues may ultimately lead to incorrect conclusions about the effects of each input category, and their relative magnitudes and directions, on the forecast items.

Embodiments of the present disclosure may provide a solution to the above problem by generating enhanced metrics, referred to herein as Applied and Indicative Explanation values (AIE-values), based on conventional SHAP quantities that are generating by existing machine learning forecasting engines. The AIE-values generated in accordance with the present disclosure include relative magnitude and directions of the effects of different features across forecast items and forecast times, groupings of forecast items together based on scale, and normalized magnitude and direction of the effects of different features across forecast items and forecast times. The AIE-values may be displayed in a graphical user interface with improved usability, which may enable a user to navigate, understand, and derive insights from the forecasts that are not readily provided by the raw SHAP quantities.

By generating AIE-values, the embodiments of the present disclosure improve the overall usability of a computer system that provides forecast prediction data by systematically transforming the raw SHAP value data into readily accessible information. Improving the usability and interpretability of the forecast prediction data reduces the time and, therefore, energy utilized by the computer system for a user to interpret the forecast model results, resulting in a reduction of computation resources compared to conventional computer systems.

Additionally, the embodiments of the present disclosure can be applied to SHAP quantities generated by conventional machine learning forecast engines, without having to perform computationally intensive retraining or reprogramming of an “explainer module” of the machine learning forecast engine that generates SHAP quantities. This provides an improved machine learning forecast computing system, which may leverage existing machine learning forecast engines, while providing results that require less computational resources to interpret.

Aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods, and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module, or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object, or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media, and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

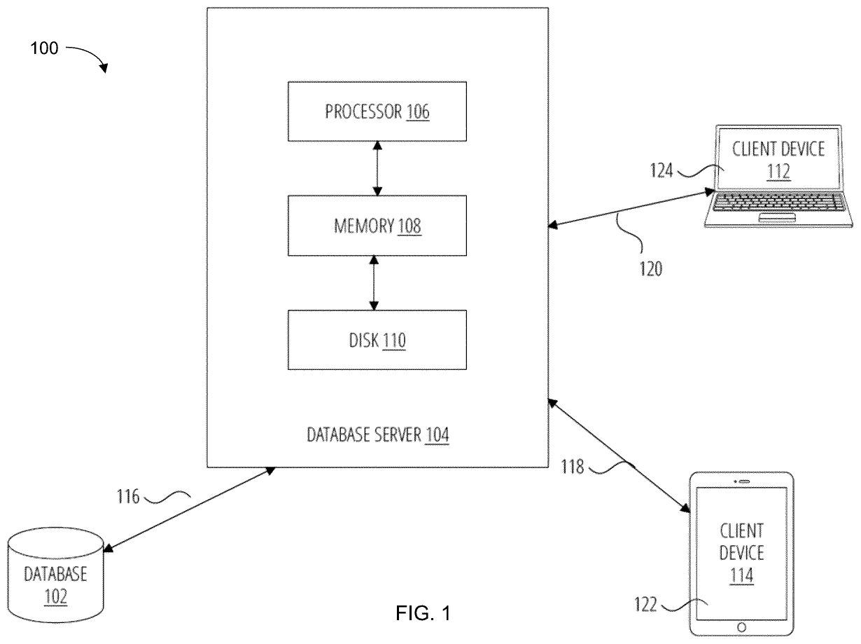

FIG. 1 illustrates an example of a system 100 for generating a graphical user interface including enhanced metrics based on SHAP quantities of a machine learning forecast model.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable, and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), real-time transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

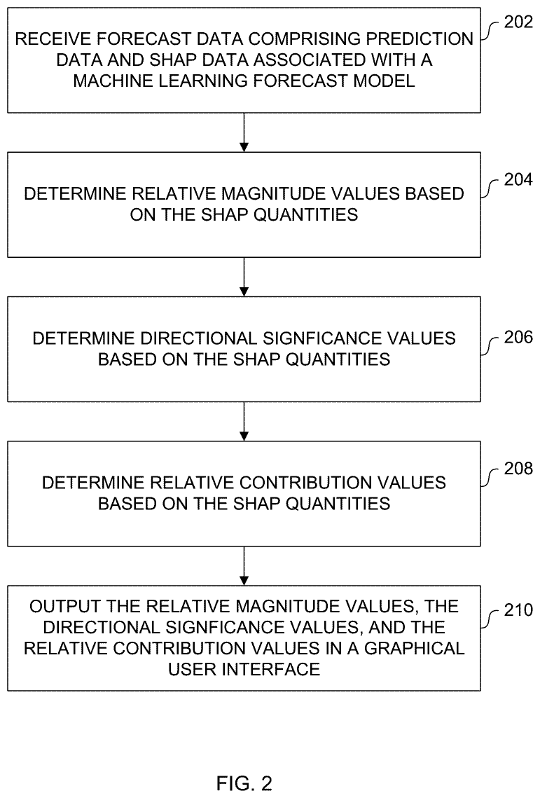

Referring now to FIG. 2, a flow chart illustrating an example computer implemented method for generating enhanced metrics based on SHAP quantities of a machine learning forecast model. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At 202, forecast data comprising prediction data and SHAP data associated with a machine learning forecast model is received. The prediction data may include a forecast prediction for each forecast item at each forecast time. The forecast items may each be associated with one of a plurality of segments. The prediction data may include a “base value” which may be an average of all of the forecast predictions for all forecast items at all forecast times. The SHAP data may include, for each input category of each forecast item at each forecast time, a SHAP quantity and an associated direction indication, which together generally indicate the magnitude and direction that the input category effected the forecast prediction of the forecast item at the forecast time. As described previously, the direction indication may be a “+” or “−” sign.

The prediction data and the SHAP data may be generated by conventional machine learning forecast engines. The SHAP data may be generated by an “explainer module” of the machine learning forecast engine.

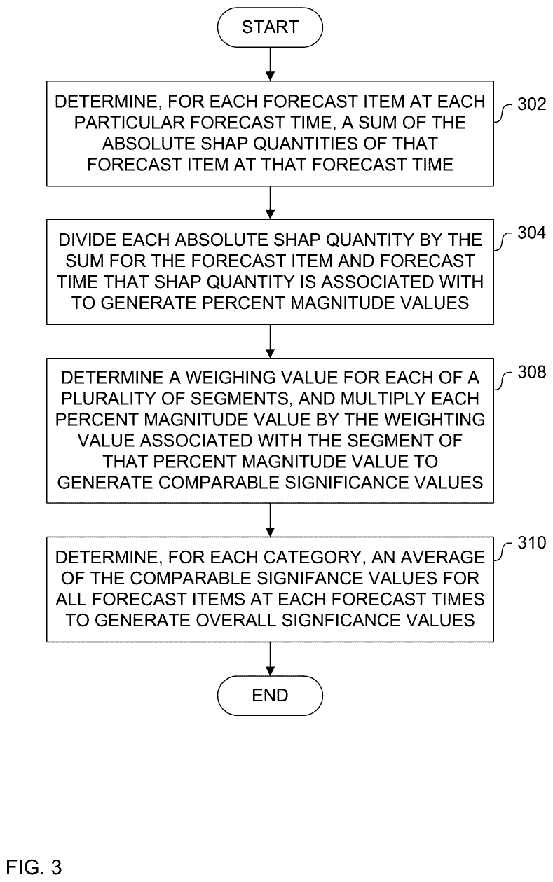

At 204, relative magnitude values are determined based on the SHAP quantities. The relative magnitude values maybe determined, for example, as described below with reference to FIG. 3.

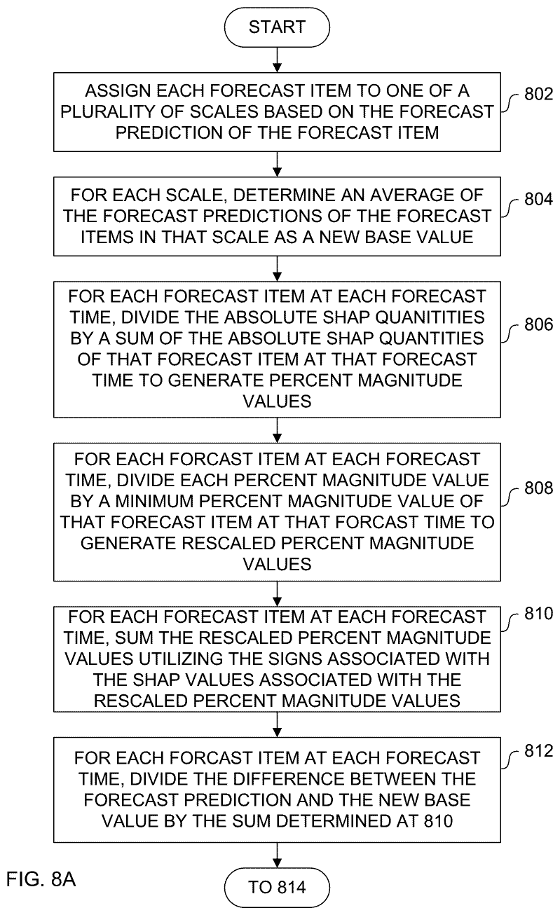

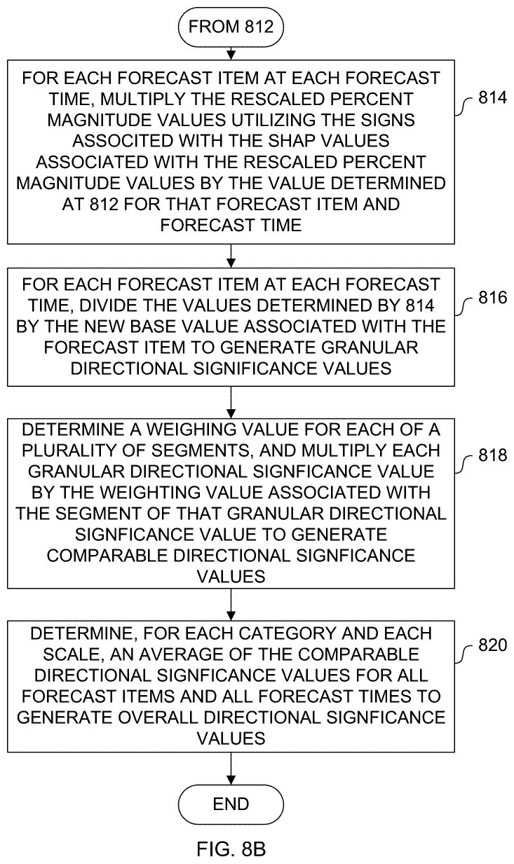

At 206, directional significance values are determined based on the SHAP quantities. The normalized magnitude values may be determined, for example, as described below with reference to FIGS. 8A and 8B.

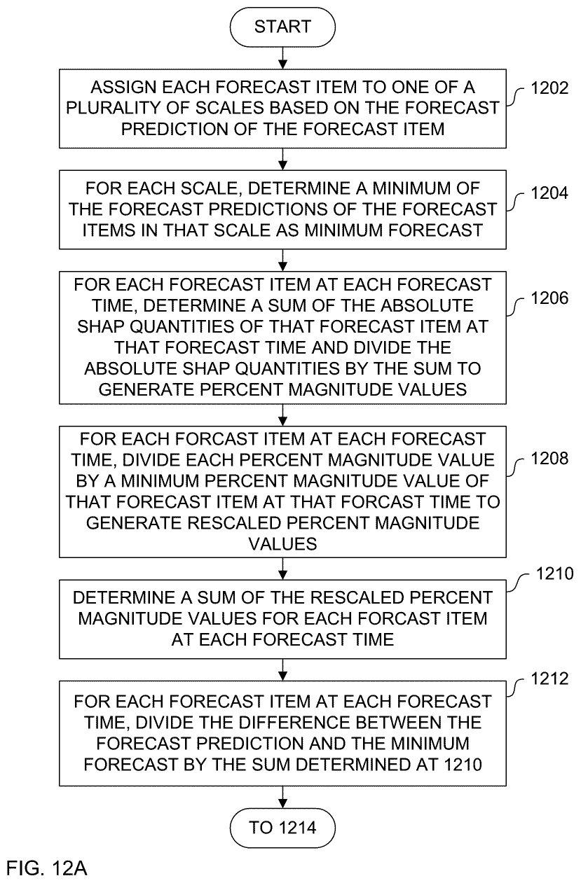

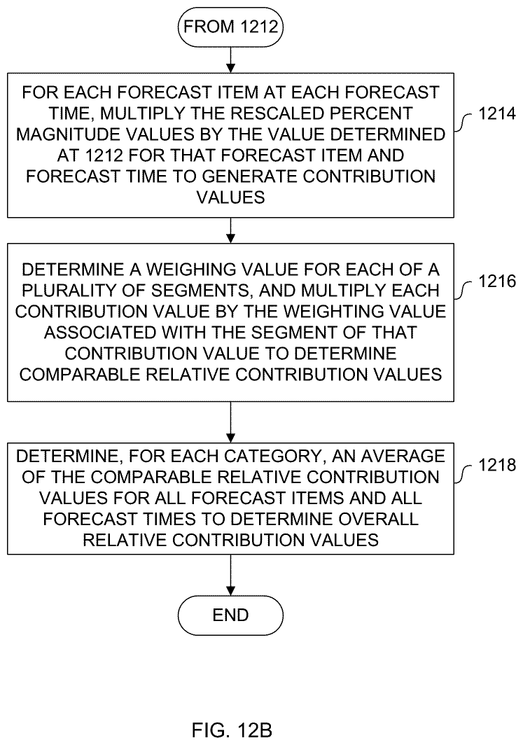

At 208, relative contribution values are determined based on the SHAP quantities. The relative contribution values may be determined, for example, as described below with reference to FIGS. 12A and 12B.

At 210, the relative magnitude values, the directional significance values, and the relative contribution values are output in a graphical user interface as Applied and Indicative Explanation values (AIE-values). The relative magnitude values, the directional significance values, and the relative contribution values may be output in graphical user interface to a client device, such as the client device 112 or the client device 114 described previously with reference to FIG. 1, for displaying on a display of the client device.

Referring now to FIG. 3, a flow chart illustrating an example computer implemented method for generating relative magnitude values based on SHAP quantities of a machine learning forecast model at step 204 of FIG. 2 is shown. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At 302, a sum of the absolute SHAP quantities is determined for each forecast item at each forecast time.

At 304, each absolute SHAP value of a forecast item at a forecast time is divided by the sum determined at 302 for the forecast item at the forecast time that that SHAP value is associated with to generate “percent magnitude values” for each category. Reference in the present disclosure to an operation that utilizes an absolute SHAP value means that the operation does not utilize the sign associated with the SHAP value that indicates directionality, such as, for example, a “+” or “−” sign as described previously.

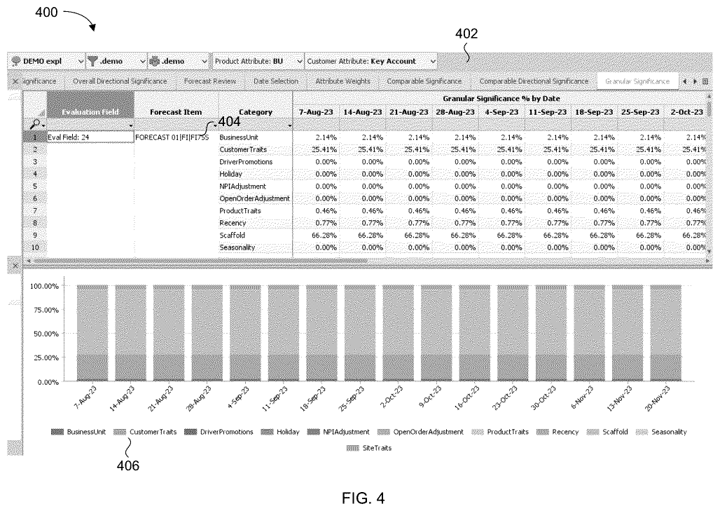

Outputting the relative magnitude values at 208 of FIG. 2 may include outputting the percent magnitude values in the graphical user interface. Referring to FIG. 4, a screenshot 400 of an example graphical user interface 402 displaying example percent magnitude values is shown. In the example graphical user interface 402, the percent magnitude values of a selected forecast item 404, are shown in a graph 406 that illustrates, for each forecast time, the percent magnitude values of the different input categories in a bar graph format. This view may be useful when a user wants to focus on a specific forecast item and compare the differences between input category influences at a certain time, or over time.

Referring back to FIG. 3, at 308, a weighting value is determined, and each percent magnitude value is multiplied by the weighting factor to generate comparable significance data.

As described previously, each forecast item may be associated with one of a plurality of segments. A segment may be any type of data categorization. For example, each segment may relate to a different brand of products and may be used to group forecast items with some mutual attributes. In an example, each segment may have an associated weighting value. In this example, the percent magnitude values are multiplied by the weighting value corresponding to the segment associated with the forecast item of the percent magnitude value.

The weighting value of a segment may be determined as the sum of all forecast predictions of all forecast items at all forecast times in that segment divided by the sum of all forecast predictions of all forecast items at all forecast times in all segments.

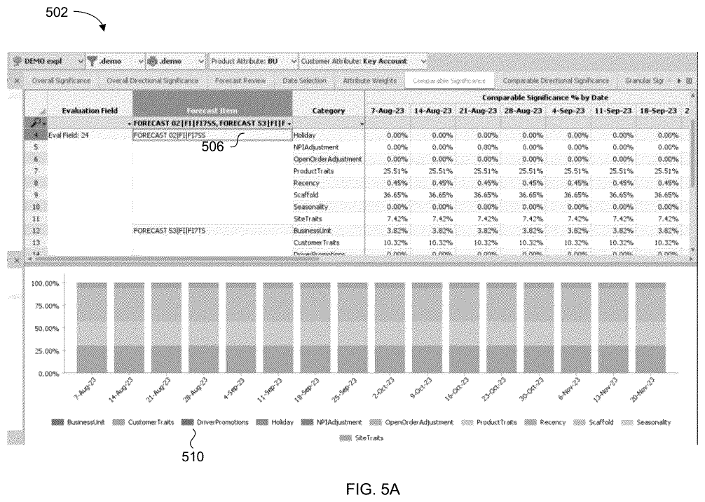

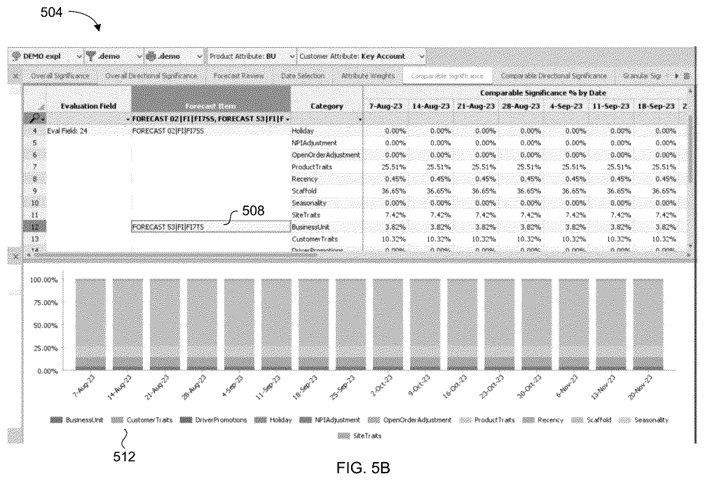

Outputting the relative magnitude values at 210 of FIG. 2 may include outputting the comparable significance values determined at 308 in the graphical user interface. Referring to FIGS. 5A and 5B, respective graphical user interfaces 502, 504 are shown that include example comparable significance values for different forecast items. The comparable significance values output in the graphical user interfaces 502, 504 facilitate comparing significances, i.e., influential input categories, across different forecast items. In the example graphical user interfaces 502, 504 the comparable significance values of selected forecast item 506, 508 respectively, are shown in graphs 510, 512. The graphs 510, 512 illustrate, for each forecast time, the comparable significance values of the different input categories of the selected forecast items 506, 508 in a bar graph format. The comparable significance values shown in the graphical user interfaces 502, 504 may facilitate interpreting the differences in terms of influential input categories on the forecasts between two forecast items 506, 508 that may be not readily interpretable from the raw SHAP values. In the example shown, the example forecast items have forecast predictions that are significantly different which would make comparing these two forecasts challenging when relying on the raw SHAP quantities.

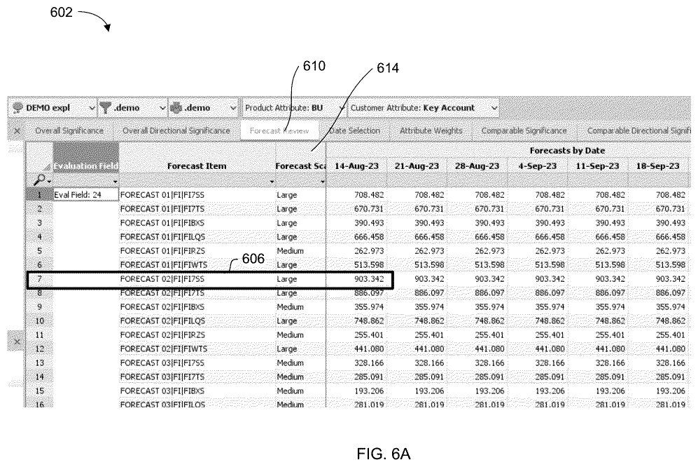

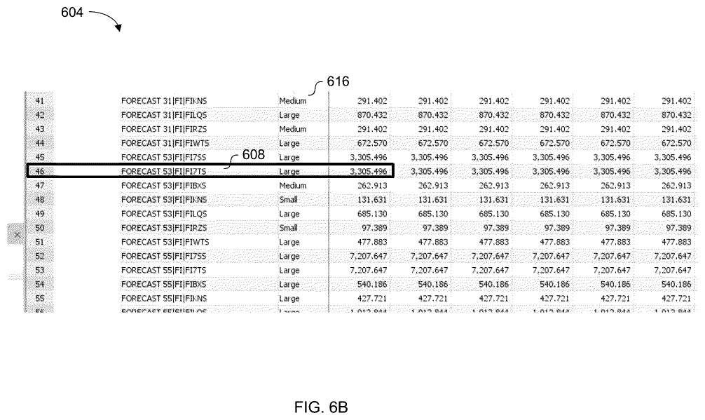

For example, FIGS. 6A and 6B illustrate graphical user interfaces 602, 604 respectively that show the forecast predictions for the different forecast items at different forecast times. Forecast item 506 includes forecast prediction of 903.342, as highlighted by the box 606 in graphical user interface 602, and forecast item 508 includes a forecast prediction of 3,305.496, as highlighted by the box 608 in graphical user interface 604. Comparing the influence of the different input categories utilizing the raw SHAP quantities of these two forecast items would be challenging given the significant discrepancy in the forecast predictions. However, the comparable significance values facilitate comparing the effect between forecast items by appropriately weighting to percentage magnitude values, rather than raw SHAP quantities. In the example graphical user interface 602, 604, the forecast predictions are viewed by selecting the “Forecast Review” table 610.

Referring back to FIG. 3, at 310, an average of the comparable significance values is determined for each input category for all forecast items at each forecast time for all segments to generate overall significance values.

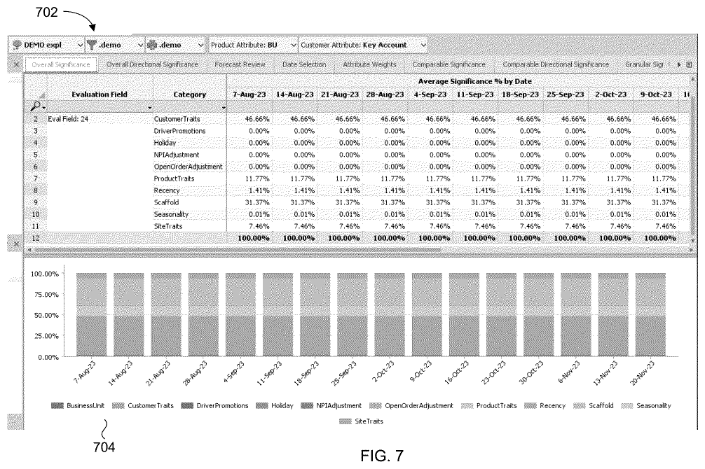

Outputting the relative magnitude values at 210 of FIG. 2 may include outputting the overall significance values determined at 310 in the graphical user interface. Referring to FIG. 7, an example graphical user interface 702 that includes the overall significance values is shown. The graphical user interface includes a graph 704 of the overall significance values. The graphical user interface 702 shows percentage of input categories' magnitude of influences and facilitate an overall insight relates to the most influential features on the forecast predictions of all forecast items, which in the example shown is CustomerTraits and Scaffold. The values may be comparable at a certain time or across all times and input categories.

Referring now to FIGS. 8A and 8B, a flow chart illustrating an example computer implemented method for generating directional significance values based on SHAP quantities of a machine learning forecast model at step 206 of FIG. 2 is shown. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At 802, each forecast item is assigned to one of a plurality of scales based on the forecast prediction included in the prediction data for that forecast item. Each of the plurality of scales may have, for example, a threshold associated with it such that the forecast predictions are compared to the thresholds to assign the corresponding the forecast items to one of the scales. In an example, three scales, referred to as “small”, “medium”, and “large” may be provided, each associated with a threshold such as, for example, forecast items having forecast predictions less than 100 may be assigned to the “small” scale, forecast items having forecast predictions greater than 100 and less than 250 may be assigned to the “medium” scale, and forecast items having a forecast predictions greater than 250 may be assigned to the “large” scale.

Assigning different forecast items to different scales may provide facilitate a more accurate understanding of direction of input categories' effects. SHAP quantities are typically referenced to the base value, which is average of all forecast predictions in the prediction data. Referencing SHAP quantities with one overall average for all forecast items in the context of a potentially large distribution of forecast predictions may result in incorrect interpretation of effects, in particular for direction of effects. By separating different forecast items into different scales, the average of the forecast prediction in the scale provides a more useful reference point for the SHAP quantities of those forecast items.

For example, the average of forecast predictions in the range of 0 to 100 may be ˜60, for example, and for a forecast item with forecast quantity=90, some positive effects for input categories become more readily apparent when referenced with this average compared to the average of all forecast predictions, i.e., the base value of all forecast items, from, for example, 0 to 800 which may be, for example, ˜200. In the latter case, the same forecast item may be interpreted as having many negative effects, mainly due to the fact that the forecast prediction of 90 is far less than the overall average of forecast predictions of 200.

In practice, any number of scales, having any associated thresholds, may be provided and may be selected based on the use case and the distribution of the forecast predictions that are generated by the machine learning forecast engine. For example, for forecast predictions related to consumer packaged goods with long tailed forecast prediction distribution, the thresholds for the “small”, “medium”, and “large” scales may be set to 20% lower and 50% higher than the base value, or overall average, of forecast predictions. In this case, “small” scale threshold would be less than 20% lower than the base value, “medium” scale threshold would be greater than 20% lower and less than 50% higher than the base value, and the “large” scale threshold would be greater than 50% higher than the base value.

Outputting the directional significance values at 210 of FIG. 2 may include outputting in the graphical user interface the assigned scale for each forecast item as determined at 802. For example, in the graphical user interface 602, 604 displayed in FIGS. 6A and 6B when the “Forecast Review” tab 610 is selected, a column 614, 616 includes the scale that each forecast item is assigned to.

At 804, an average of the forecast predictions is determined for each scale. The average is determined by averaging the forecast predictions of all of the forecast items assigned to that particular scale. This average of the forecast predictions for the scale becomes a new base value associated with that scale, replacing the conventional base value that is the average of all of the forecast predictions.

At 806, the absolute SHAP quantities of each forecast item at each forecast time are divided by the sum of the absolute SHAP quantities of that forecast item at that forecast time to generate percent magnitude values. The generation of the percent magnitude values at 806 is substantially similar to the generation of the percent magnitude values at steps 302 and 304 described previously with reference to FIG. 3.

At 808, each percent magnitude value of each forecast item and each forecast time is divided a minimum of the percent magnitude values of that forecast item at that forecast time to generate rescaled percent magnitude values.

At 810, the rescaled percent magnitude values determined at 808 are summed for each forecast item at each forecast time, utilizing the signs associated with SHAP values that are associated with each rescaled percent magnitude values. As described previously, the SHAP data includes a direction indicator in the form of a “+” or a “−” sign. Therefore, rescaled percent magnitude values that have an associated “+” sign for a direction indicator will increase the sum determined at 810, and conversely, rescaled percent magnitude values that have associated “−” sign will reduce the sum determined at 810.

At 812, for each forecast item at each forecast time, the difference between the forecast prediction for that forecast item at that forecast time and the new base value determined at 804 is divided by the sum determined at 810 for that forecast item at that forecast time.

At 814, the rescaled percent magnitude values determined at 808 for each forecast item at each forecast time are multiplied, utilizing the signs associated with SHAP values that are associated with each rescaled percent magnitude values, by the value determined at 812 for that forecast item at that forecast time. Therefore, each of the products generated at 814 have the sign, e.g., “+” or “−”, of the SHAP value that is associated with the rescaled percent magnitude value used to generate that product.

At 816, the values determined 814 for each forecast item at each forecast time are divided by the new base value determined at 804 for that forecast item to generate granular directional significance values.

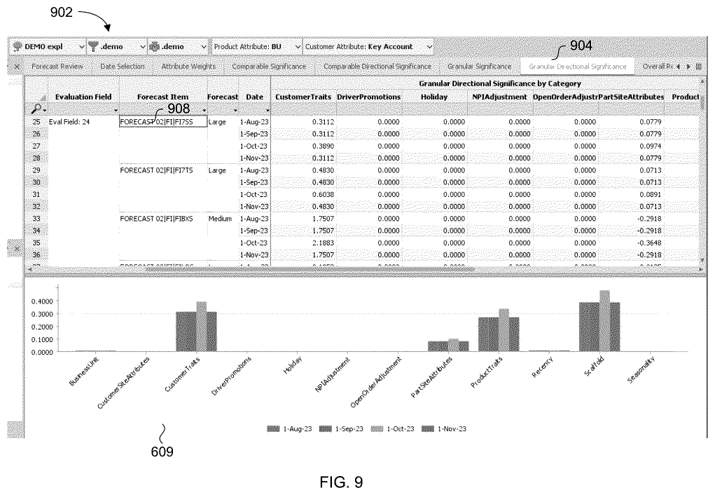

Outputting the directional significance values at 210 of FIG. 2 may include outputting in the graphical user interface the granular directional significance values determined at 816. Referring to FIG. 9, a graphical user interface 902 is shown that displays example granular directional significance values. The graphical user interface 902 may be displayed by selecting the “Granular Directional Significance” tab 904. The example graphical user interface 902 includes a graph 906 showing the granular directional significance values associated with a selected forecast item 908. The example graph 906 shows the granular directional significance values by input category for different forecast times for the selected forecast item 908. Similar to the example graphical user interface 402 for outputting granular significance values that is shown in FIG. 4, this graphical user interface 902 showing granular directional significance values may be useful for interpreting a particular forecast item to gain further detailed insights regarding the effects of the input categories for that forecast item alone, rather than in comparison with other forecast items.

At 818, a weighing value is determined for each segment, and each granular directional significance value is multiplied by the weighing value associated with the segment of that granular directional significance value to generate comparable significance values. The weighing values are determined similarly to the weighing values determined at 308 as described previously with reference to FIG. 3.

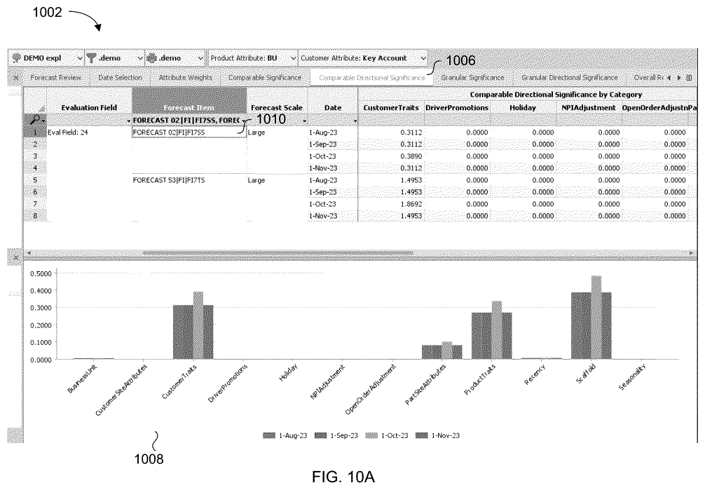

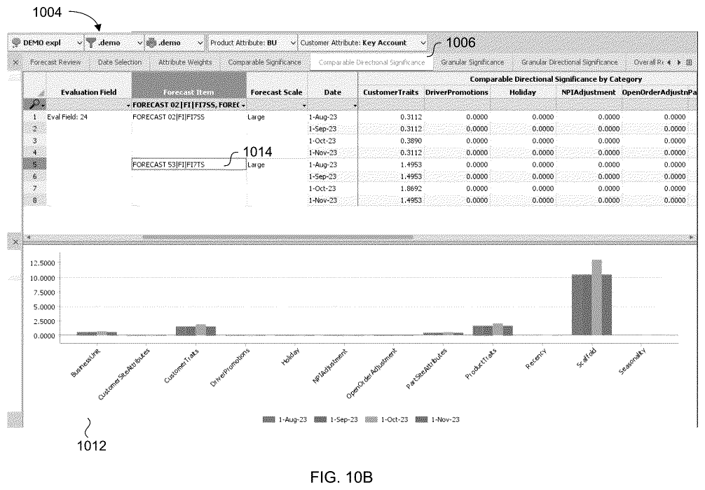

Outputting the directional significance values at 210 of FIG. 2 may include outputting in the graphical user interface the comparable directional significance values determined at 818. Referring to FIGS. 10A and 10B, example graphical user interfaces 1002, 1004 are shown that display example comparable directional significance values. The graphical user interfaces 1002, 1004 may be displayed by selecting the “Comparable Directional Significance” tab 1006. The example graphical user interface 1002 includes a graph 1008 showing the comparable directional significance values associated with a selected forecast item 1010, and the example graphical user interface 1004 includes a graph 1012 showing the comparable directional significance values associated with a selected forecast item 1014. The example graphs 1008, 1012 show the comparable directional significance values by input category for different forecast times for the selected forecast item 1010, 1014 respectively.

The graphical user interfaces 1002, 1004 displaying comparable directional

significance values facilitates comparing direction and significance of influences of the input categories between different forecast items 1010, 1014. For example, the graphs 1008, 1012 may facilitate making interpretations regarding how different input categories affect the forecast predictions of the selected forecast items 1010, 1014 to understand the differences between them.

Referring back to FIG. 8B, at 820, an average of the comparable directional significance values is determined for each input category over all forecast items and all forecast times of each scale to generate overall directional significance values.

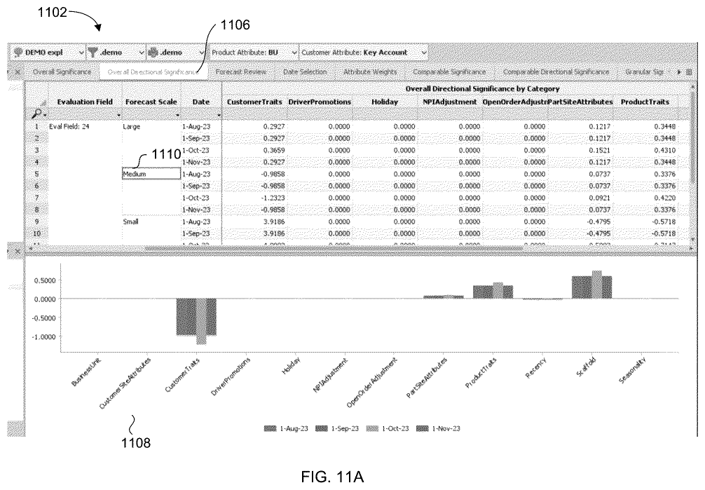

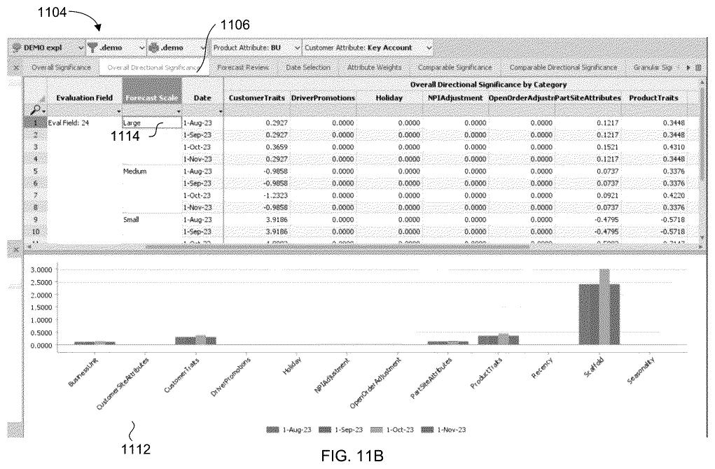

Outputting the directional significance values at 210 of FIG. 2 may include outputting in the graphical user interface the overall directional significance values determined at 820. Referring to FIGS. 11A and 11B, example graphical user interfaces 1102, 1104 are shown that display example overall directional significance values for each of “small”, “medium” and “large” scales. The graphical user interfaces 1102, 1104 may be displayed by selecting the “Overall Directional Significance” tab 1106. The example graphical user interface 1102 includes a graph 1108 showing the overall directional significance values associated with a selected “medium” scale 1110, and the example graphical user interface 1104 includes a graph 1112 showing the overall directional significance values associated with a selected “large” scale 1114. The example graphs 1108, 1112 show the overall directional significance values by input category for different forecast times for the selected scales 1110, 1114 respectively. In the example graphs 1108, 112, an overall view for directional significance for 4 months (Aug to Nov) is provided that visualizes the SHAP data for different sized forecast prediction scales in a way that accounts for the distribution of forecast predictions and enables more readily comparing the differences in the influence of the input categories between the forecast scales.

Given that the predication data typically includes a range of forecast predictions as described above, and may range from very small to large or even very large, and the raw SHAP quantities do not sufficiently consider the differences between these different forecast prediction scales, the raw SHAP quantities do not easily facility gaining accurate insights to the direction of influences of different input categories, as describe previously.

The graphical user interfaces 1102, 1104 that output overall directional significance values for each scale may more easily facilitate an accurate understanding of direction, in addition to the magnitude of influences, according to the different forecast scales, also, facilitate more easily comparing influences across different forecast scales, and times. This results in greater usability of the computer system that includes a graphical user interface outputting the overall directional significance values, as well as the comparable directional significance values and the granular directional significance values, compared to a computer system that includes only the raw SHAP quantities.

Referring now to FIGS. 12A and 12B, a flow chart illustrating an example computer implemented method for generating relative contribution values based on SHAP quantities of a machine learning forecast model at step 208 of FIG. 2 is shown. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At 1202, each forecast item is assigned to one of a plurality of scales based on the forecast prediction of the forecast item. This assigning is performed similarly to the assigning performed at 802, described previously with reference to FIG. 8A, and therefore is not described further here.

At 1204, a minimum of the forecast prediction of the forecast items in a scale is determined for each of the scales.

At 1206, the absolute SHAP quantities of each forecast item at each forecast time are divided by the sum of the absolute SHAP quantities of that forecast item at that forecast time to generate percent magnitude values. The generation of the percent magnitude values at 1206 is substantially similar to the generation of the percent magnitude values at steps 302 and 304 described previously with reference to FIG. 3.

At 1208, each percent magnitude value of each forecast item and each forecast time is divided by a minimum of the percent magnitude values of that forecast item at that forecast time to generate rescaled percent magnitude values.

At 1210, the rescaled percent magnitude values are summed for each forecast time at each forecast time. The summing performed at 1210 is different than the summing performed at 810 described previously with reference to FIG. 8A in that the summing at 1210 does not utilize the directional indication signs associated with the rescaled percent magnitude values, and rather a sum of the absolute values is performed.

At 1212, for each forecast item at each forecast time, the difference between the forecast prediction for that forecast item and that forecast time and the minimum forecast prediction determined at 1204 for the scale of that forecast item is divided by the sum of the rescaled percent magnitude values determined at 1210 for that forecast item at that forecast time.

At 1214, for each forecast item at each forecast time, the rescaled percent magnitude values determined at 1208 for that forecast item at that forecast time are multiplied by the value determined at 1212 for that forecast item at that forecast time to generate contribution values.

At 1216, a weighing value is determined for each segment, and each contribution value is multiplied by the weighing value associated with the segment of that contribution value to generate comparable relative contribution values. The weighing values are determined similarly to the weighing values determined at 308 as described previously with reference to FIG. 3.

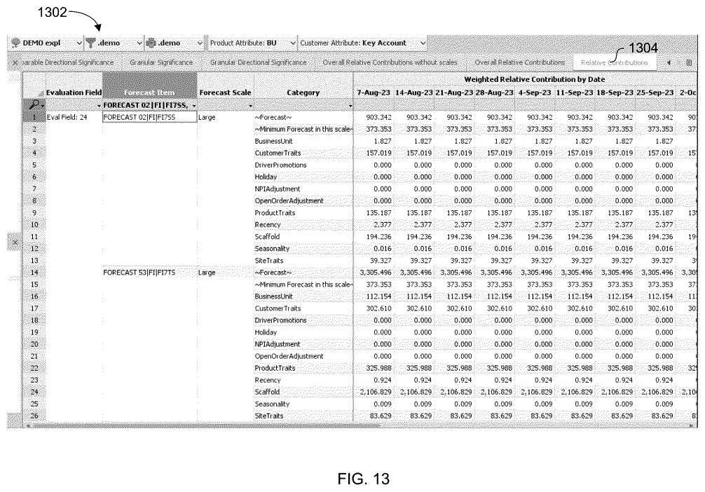

Outputting the relative contribution values at 210 of FIG. 2 may include outputting in the graphical user interface the comparable relative contribution values determined at 1216. Referring to FIG. 13, an example graphical user interface 1302 is shown that displays example comparable relative contribution values. The graphical user interface 1302 may be displayed by selecting the “Relative Contributions” tab 1304. The comparable relative contribution values shown in graphical user interface 1302 may facilitate reviewing contributions or influences of different input categories to different forecast items, and to compare them across different forecast items at different times.

At 1218, an average of the comparable relative contribution values determined at 1216 is determined for each input category over all forecast items and all forecast times of each scale to generate overall relative contributions.

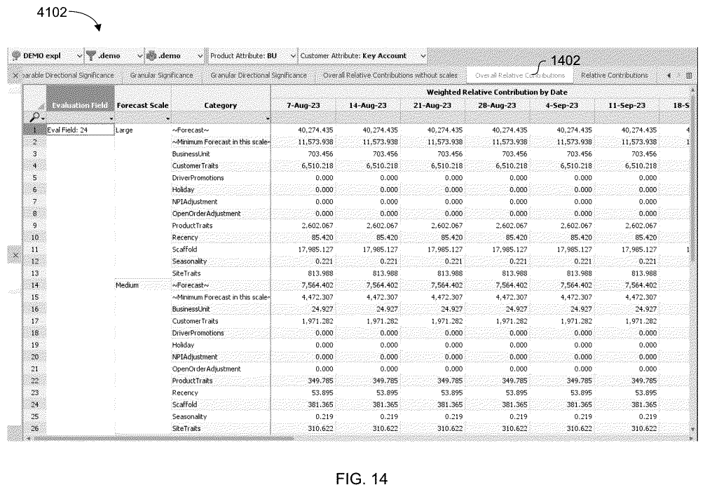

Outputting the relative contribution values at 208 of FIG. 2 may include outputting in the graphical user interface the overall relative contribution values determined at 1218. Referring to FIG. 14, an example graphical user interface 1402 is shown that displays example overall relative contribution values for each of a “small” (not shown), a “medium”, and a “large” scale. The graphical user interface 1402 may be displayed by selecting the “Overall Relative Contributions” tab 1404. The overall relative contribution values shown in graphical user interface 1402 may facilitate further insights into the contribution of features to forecasts in a quantitative form because the sum of the contributions of all input categories is attributable to the forecast predictions.

According to one or more embodiments, the present disclosure describes a system and method for generating an improved graphical user interface for interpreting SHAP quantities. The system and method may include a number of aspects including: receiving forecast data related to a machine learning forecast model that includes, for each input category of each forecast item at each forecast time, a SHAP quantity and a sign indicating a directionality of the SHAP quantity, based on the SHAP quantities, generating, relative magnitude values, directional significance values, and relative contribution values, and outputting in a graphical user interface the relative magnitude values, the directional significance values, and the relative contribution values as Applied and Indicative Explanation values (AIE-values). Such a solution addresses issues with existing approaches by facilitating interpretation of the SHAP quantities more easily to make accurate interpretations of the contribution of input categories to the forecast predictions generated by a machine learning forecast engine, improving the usability of the computer system.

The AIE-values that are incorporated into in a graphical user interface in the embodiments of the present disclosure enable a user to navigate, understand, and derive insights from the forecasts that are not readily provided by the raw SHAP data, resulting in improved usability, and facilitating more accurate interpretations of the influence of input categories on the forecast predictions for various forecast items over time. For example, the AIE-values, as well as the visualizations enabled by the graphical user interface of the embodiments described herein, a user can make better decisions with an improved understanding of complex relationships within a supply chain network in way that could not have been easily deduced from raw SHAP values. Problem detection, investigation, evaluation and resolution may be faster using AIE-values compared to use of a spreadsheet-based or tabular visualization of raw SHAP values.

By generating and displaying a graphical user interface that includes enhanced metrics, referred to as AIE-values, the overall functioning of the computer system, such as the example system 100 described previously, may be improved by enhancing the usability of the computer system. Such improvements to the usability may result in, for example, reduced computing time, reduced computer memory requirements, and reduced computer processor requirements for interpreting SHAP quantities, compared to known approaches, while also facilitate more accurate interpretations of the influence of input categories on the forecast predictions for various forecast items over time. Such improvements and solutions to computer problems are achieved by the methods of one or more of the embodiments described and illustrated herein.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving forecast data related to a machine learning forecast model that includes, for each input category of each forecast item at each forecast time, a SHAP quantity and a sign indicating a directionality of the SHAP quantity;
based on the SHAP quantities, generating:
relative magnitude values;
directional significance values, and
relative contribution values;
outputting in a graphical user interface the relative magnitude values, the directional significance values, and the relative contribution values as Applied and Indicative Explanation values (AIE-values).

2. The computer-implemented method according to claim 1, wherein generating the relative magnitude values comprises, for each forecast item at each forecast time:
determining, a sum of the absolute SHAP quantities of the forecast item at the forecast time;
dividing each absolute SHAP quantity of the forecast item at the forecast time by the determined sum of the absolute SHAP quantities for the forecast item and forecast time to generate, for each category, a percent magnitude value,
wherein outputting in a graphical user interface the relative magnitude values comprises outputting in a graphical user interface the percent magnitude values.

3. The computer-implemented method according to claim 1, wherein each of the forecast items in the forecast data is associated with one of a plurality of segments, and generating the relative magnitude values comprises, for each forecast item at each forecast time:
determining a weighting value for each of the plurality of segments;
multiplying each percent magnitude value by the weighting value of the segment that is associated with the forecast item that the percent magnitude value is associated with to generate a comparable significance value;
wherein outputting in the graphical user interface the relative magnitude values comprises outputting in the graphical user interface the comparable significance values.

4. The computer-implemented method according to claim 3, wherein the forecast data includes, for each forecast item at each time, an associated forecast prediction, and wherein determining the weighting factor for each of the plurality of segments comprises, for each segment dividing the sum of all forecast predictions of all forecast items associated with segment at all forecast times by the sum of all forecast predictions of all forecast items at all forecast times for all segments.

5. The computer-implemented method according to claim 3, wherein generating the relative magnitude values comprises, for each input category, determining an average of the comparable significance values for all forecast items for all segments at each forecast time to generate an overall significance value;
wherein outputting in the graphical user interface the relative magnitude values comprises outputting in the graphical user interface the overall significance values.

6. The computer-implemented method according to claim 1, wherein the forecast data includes, for each forecast item at each time, an associated forecast prediction, and wherein generating the directional significance values comprises:
assigning each forecast item to one of a plurality of scales based on the forecast prediction associated with the forecast item;
determining, for each scale, an average of the forecast predictions associated with the forecast items in the scale and setting the determined average to be a new base value;
for each forecast item at each time:
dividing each of the absolute SHAP quantities of the forecast item at the forecast time by a sum of the absolute SHAP quantities of the forecast item at the forecast time to determine percent magnitude values;
determining a minimum of the percent magnitude values and dividing the percent magnitude values by the minimum percent magnitude value to generate rescaled percent magnitude values;
for each rescaled percent magnitude value, including the sign indicating direction associated with the SHAP quantity associated with the rescaled percent magnitude value and summing of the rescaled percent magnitude values with signs;
determining a difference between the forecast prediction of the forecast item at the forecast time and the new base value;
dividing the difference by the sum of the rescaled percent magnitude values with signs;
multiplying the rescaled percent magnitude values by the result of dividing the difference by the sum of the rescaled percent magnitude values with signs and dividing the result by the new base value of the segment to generate granular directional significance values; and
wherein outputting in the graphical user interface the directional significance values comprises outputting in the graphical user interface the granular directional significance values.

7. The computer-implemented method according to claim 1, wherein the forecast data includes, for each forecast item at each time, an associated forecast prediction, wherein each of the forecast items in the forecast data is associated with one of a plurality of segments, and wherein generating the relative contribution values comprises:
assigning each forecast item to one of a plurality of scales based on the forecast prediction associated with the forecast item;
determining, for each scale, a minimum forecast prediction as the minimum forecast;
determining a weighting value for each of the plurality of segments;
for each forecast item at each time:
dividing each of the absolute SHAP quantities of the forecast item at the forecast time by a sum of the absolute SHAP quantities of the forecast item at the forecast time to determine percent magnitude values;
determining a minimum of the percent magnitude values and dividing the percent magnitude values by the minimum percent magnitude value to generate rescaled percent magnitude value;
summing the rescaled percent magnitude values;
determining a difference between the forecast prediction of the forecast item at the forecast time and the minimum forecast;
dividing the difference by the sum of the rescaled percent magnitude values;
multiplying the rescaled percent magnitude values by the result of dividing the difference by the sum of the rescaled percent magnitude values to generate contribution values; and
multiplying each contribution value by the weighting value of the segment that is associated with the forecast item that the contribution value is associated with to generate comparable relative contribution values;
wherein outputting in the user interface the relative contribution values comprises outputting in the user interface the comparable relative contribution values.

8. A system comprising:
a processor; and
a memory storing instructions that, when executed by the processor, configure the system to:
receive forecast data related to a machine learning forecast model that includes, for each input category of each forecast item at each forecast time, a SHAP quantity and a sign indicating a directionality of the SHAP quantity;
based on the SHAP quantities, generate:
relative magnitude values;
directional significance values, and
relative contribution values;
output in a graphical user interface the relative magnitude values, the directional significance values, and the relative contribution values as Applied and Indicative Explanation values (AIE-values).

9. The system according to claim 8, wherein the memory storing instructions that, when executed by the processor, configure the system to generate the relative magnitude values comprises the memory storing instructions that, when executed by the processor, configure the system to, for each forecast item at each forecast time:
determine, a sum of the absolute SHAP quantities of the forecast item at the forecast time;
divide each absolute SHAP quantity of the forecast item at the forecast time by the determined sum of the absolute SHAP quantities for the forecast item and forecast time to generate, for each category, a percent magnitude value,
wherein the memory storing instructions that, when executed by the processor, configure the system to output in a graphical user interface the relative magnitude values comprises the memory storing instructions that, when executed by the processor, configure the system to output in a graphical user interface the granular significance values.

10. The system according to claim 8, wherein each of the forecast items in the forecast data is associated with one of a plurality of segments and wherein the memory storing instructions that, when executed by the processor, configure the system to generate the relative magnitude values comprises the memory storing instructions that, when executed by the processor, configure the system to, for each forecast item at each forecast time:
determine a weighting value for each of the plurality of segments;
multiply each percent magnitude value by the weighting value of the segment that is associated with the forecast item that the percent magnitude value is associated with to generate a comparable significance value;
wherein the memory storing instructions that, when executed by the processor, configure the system to output in a graphical user interface the relative magnitude values comprises the memory storing instructions that, when executed by the processor, configure the system to output in the graphical user interface the comparable significance values.

11. The system according to claim 10, wherein the forecast data includes, for each forecast item at each time, an associated forecast prediction and wherein the memory storing instructions that, when executed by the processor, configure the system to determine the weighting factor for each of the plurality of segments comprises the memory storing instructions that, when executed by the processor, configure the system to, for each segment, divide the sum of all forecast predictions of all forecast items associated with segment at all forecast times by the sum of all forecast predictions of all forecast items at all forecast times for all segments.

12. The system according to claim 10, wherein the memory storing instructions that, when executed by the processor, configure the system to generate the relative magnitude values comprises the memory storing instructions that, when executed by the processor, configure the system to, for each input category, determine an average of the comparable significance values for all forecast items for all segments at each forecast time to generate an overall significance value; and
wherein the memory storing instructions that, when executed by the processor, configure the system to output in a graphical user interface the relative magnitude values comprises the memory storing instructions that, when executed by the processor, configure the system to output in the graphical user interface the overall significance values.

13. The system according to claim 8, wherein the forecast data includes, for each forecast item at each time, an associated forecast prediction, and wherein the memory storing instructions that, when executed by the processor, configure the system to generate the directional significance values comprises the memory storing instructions that, when executed by the processor, configure the system to:
assign each forecast item to one of a plurality of scales based on the forecast prediction associated with the forecast item;
determine, for each scale, an average of the forecast predictions associated with the forecast items in the scale and setting the determined average to be a new base value;
for each forecast item at each time:
divide each of the absolute SHAP quantities of the forecast item at the forecast time by a sum of the absolute SHAP quantities of the forecast item at the forecast time to determine percent magnitude values;
determine a minimum of the percent magnitude values and dividing the percent magnitude values by the minimum percent magnitude value to generate rescaled percent magnitude values;
for each rescaled percent magnitude value, include the sign indicating direction associated with the SHAP quantity associated with the rescaled percent magnitude value and sum of the rescaled percent magnitude values with the signs;
determine a difference between the forecast prediction of the forecast item at the forecast time and the new base value;
divide the difference by the sum of the rescaled percent magnitude values with the signs;
multiply the rescaled percent magnitude values with the signs by the result of dividing the difference by the sum of the rescaled percent magnitude values with the signs and divide the result by the new base value of the segment to generate granular directional significance values; and
wherein the memory storing instructions that, when executed by the processor, configure the system to output in a graphical user interface the directional significance values comprises the memory storing instructions that, when executed by the processor, configure the system to output in the graphical user interface the granular directional significance values.

14. The system according to claim 8, wherein the forecast data includes, for each forecast item at each time, an associated forecast prediction, wherein each of the forecast items in the forecast data is associated with one of a plurality of segments, and wherein the memory storing instructions that, when executed by the processor, configure the system to generate the relative contribution values comprises the memory storing instructions that, when executed by the processor, configure the system to:
assign each forecast item to one of a plurality of scales based on the forecast prediction associated with the forecast item;
determine, for each scale, a minimum forecast prediction as the minimum forecast;
determine a weighting value for each of the plurality of segments;
for each forecast item at each time:
divide each of the absolute SHAP quantities of the forecast item at the forecast time by a sum of the absolute SHAP quantities of the forecast item at the forecast time to determine percent magnitude values;
determine a minimum of the percent magnitude values and divide the percent magnitude values by the minimum percent magnitude value to generate rescaled percent magnitude value;
sum the rescaled percent magnitude values;
determine a difference between the forecast prediction of the forecast item at the forecast time and the minimum forecast;
divide the difference by the sum of the rescaled percent magnitude values;
multiply the rescaled percent magnitude values by the result of dividing the difference by the sum of the rescaled percent magnitude values to generate contribution values; and
multiplying each contribution value by the weighting value of the segment that is associated with the forecast item that the contribution value is associated with to generate comparable relative contribution values;
wherein the memory storing instructions that, when executed by the processor, configure the system to output in a user interface the relative contribution values comprises the memory storing instructions that, when executed by the processor, configure the system to output in the user interface the comparable relative contribution values.

15. A non-transitory computer-readable medium, the computer-readable medium including instructions that when executed by a computer, cause the computer to:
receive forecast data related to a machine learning forecast model that includes, for each input category of each forecast item at each forecast time, a SHAP quantity and a sign indicating a directionality of the SHAP quantity;
based on the SHAP quantities, generate:
relative magnitude values;
directional significance values, and
relative contribution values;
output in a graphical user interface the relative magnitude values, the directional significance values, and the relative contribution values as Applied and Indicative Explanation values (AIE-values).

16. The non-transitory computer-readable medium according to claim 15, wherein the instructions that, when executed by computer, cause the computer to generate the relative magnitude values comprises instructions that, when executed by the computer, cause the computer to, for each forecast item at each forecast time:
determine, a sum of the absolute SHAP quantities of the forecast item at the forecast time;
divide each absolute SHAP quantity of the forecast item at the forecast time by the determined sum of the absolute SHAP quantities for the forecast item and forecast time to generate, for each SHAP quantity, a percent magnitude value,
wherein the instructions that, when executed by the computer, cause the computer to output in a graphical user interface the relative magnitude values comprises instructions that, when executed by the processor, configure the system to output in a graphical user interface the granular significance values.

17. The non-transitory computer-readable medium according to claim 15, wherein each of the forecast items in the forecast data is associated with one of a plurality of segments and wherein the instructions that, when executed by the computer, cause the computer to generate the relative magnitude values comprises the instructions that, when executed by the computer, cause the computer to, for each forecast item at each forecast time:
determine a weighting value for each of the plurality of segments;
multiply each percent magnitude value by the weighting value of the segment that is associated with the forecast item that the percent magnitude value is associated with to generate a comparable significance value;
wherein the instructions that, when executed by the computer, cause the computer to output in a graphical user interface the relative magnitude values comprises instructions that, when executed by the computer, cause the computer to output in the graphical user interface the comparable significance values.

18. The non-transitory computer-readable medium according to claim 17, wherein the forecast data includes, for each forecast item at each time, an associated forecast prediction, and wherein the instructions that, when executed by the computer, cause the computer to determine the weighting factor for each of the plurality of segments comprises instructions that, when executed by the computer, cause the computer to, for each segment, divide the sum of all forecast predictions of all forecast items associated with segment at all forecast times by the sum of all forecast predictions of all forecast items at all forecast times for all segments.

19. The non-transitory computer-readable medium according to claim 17, wherein the instructions that, when executed by the computer, cause the computer to generate the relative magnitude values comprises instructions that, when executed by the computer cause the computer to, for each input category, determine an average of the comparable significance values for all forecast items for all segments at each forecast time to generate an overall significance value; and
wherein the instructions that, when executed by the computer, cause the computer to output in a graphical user interface the relative magnitude values comprises instructions that, when executed by the computer, cause the computer to output in the graphical user interface the overall significance values.

20. The non-transitory computer-readable medium according to claim 15, wherein the forecast data includes, for each forecast item at each time, an associated forecast prediction, and wherein the instructions that, when executed by the computer, cause the computer to generate the directional significance values comprises instructions that, when executed by the computer, cause the computer to:
assign each forecast item to one of a plurality of scales based on the forecast prediction associated with the forecast item;
determine, for each scale, an average of the forecast predictions associated with the forecast items in the scale and setting the determined average to be a new base value;
for each forecast item at each time:
divide each of the absolute SHAP quantities of the forecast item at the forecast time by a sum of the absolute SHAP quantities of the forecast item at the forecast time to determine percent magnitude values;
determine a minimum of the percent magnitude values and dividing the percent magnitude values by the minimum percent magnitude value to generate rescaled percent magnitude values;
for each rescaled percent magnitude value, include the sign indicating direction associated with the SHAP quantity associated with the rescaled percent magnitude value and sum of the rescaled percent magnitude values with the signs;
determine a difference between the forecast prediction of the forecast item at the forecast time and the new base value;
divide the difference by the sum of the rescaled percent magnitude values with the signs;
multiply the rescaled percent magnitude values with the signs by the result of dividing the difference by the sum of the rescaled percent magnitude values with the signs and divide the result by the new base value of the segment to generate granular directional significance values; and
wherein the instructions that, when executed by the computer, cause the computer to output in a graphical user interface the directional significance values comprises instructions that, when executed by the computer, cause the computer to output in the graphical user interface the granular directional significance values.

21. The non-transitory computer-readable medium according to claim 15, wherein the forecast data includes, for each forecast item at each time, an associated forecast prediction, wherein each of the forecast items in the forecast data is associated with one of a plurality of segments, and wherein the instructions that, when executed by the computer, cause the computer to generate the relative contribution values comprises instructions that, when executed by the computer, cause the computer to:
assign each forecast item to one of a plurality of scales based on the forecast prediction associated with the forecast item;
determine, for each scale, a minimum forecast prediction as the minimum forecast;
determine a weighting value for each of the plurality of segments;
for each forecast item at each time:
divide each of the absolute SHAP quantities of the forecast item at the forecast time by a sum of the absolute SHAP quantities of the forecast item at the forecast time to determine percent magnitude values;
determine a minimum of the percent magnitude values and divide the percent magnitude values by the minimum percent magnitude value to generate rescaled percent magnitude value;
sum the rescaled percent magnitude values;
determine a difference between the forecast prediction of the forecast item at the forecast time and the minimum forecast;
divide the difference by the sum of the rescaled percent magnitude values;
multiply the rescaled percent magnitude values by the result of dividing the difference by the sum of the rescaled percent magnitude values to generate contribution values; and
multiplying each contribution value by the weighting value of the segment that is associated with the forecast item that the contribution value is associated with to generate comparable relative contribution values;
wherein the instructions that, when executed by the computer, cause the computer to output in a user interface the relative contribution values comprises instructions that, when executed by the computer, cause the computer to output in the user interface the comparable relative contribution values.
